(19) United States
(12) Patent Application Publication
(10) Pub. No.: US 2012/0026579 A1
(43) Pub. Date: Feb. 2, 2012

(54) Resonant Optical Amplifier

(75) Inventors: Jian Liu, Sunnyvale, CA (US); Peng Wan, Santa Clara, CA (US); Lihmei Yang, Palo Alto, CA (US)

(73) Assignee: POLARONYX, INC., San Jose, CA (US)

(21) Appl. No.: 12/846,810

(22) Filed: Jul. 29, 2010

(51) Int. Cl. H01S 3/094

(52) U.S. Cl. 359/345

(57) ABSTRACT

Methods and systems for resonant optical amplification are disclosed, including generating electromagnetic radiation from a seed laser; coupling the seed laser electromagnetic radiation into an etalon, wherein the etalon comprises a gain medium comprising a gain, a length, and a roundtrip gain, wherein the gain medium is positioned between a first reflective surface comprising a first power reflectivity and a second reflective surface comprising a second power reflectivity; optically or electrically pumping the gain medium using a flash lamp, an arc lamp, a laser, an electric glow discharge, or an electric current to generate an amplified seed laser electromagnetic radiation; and coupling out the amplified seed laser electromagnetic radiation from the etalon. Other embodiments are described and claimed.

### I. STATEMENT REGARDING FEDERALLY SPONSORED RESEARCH

The U.S. Government has a paid-up license in this invention and the right in limited circumstances to require the patent owner to license others on reasonable terms as provided for by the terms of the contracts NNX09CB28C awarded by The National Aeronautics and Space Administration.

### II. BACKGROUND

The invention relates generally to the field of optical amplifiers.

### III. SUMMARY

In one respect, disclosed is a method for resonant optical amplification, the method comprising: generating electromagnetic radiation from a seed laser; coupling the seed laser electromagnetic radiation into an etalon, wherein the etalon comprises a gain medium comprising a gain, a length, and a roundtrip gain, wherein the gain medium is positioned between a first reflective surface comprising a first power reflectivity and a second reflective surface comprising a second power reflectivity; optically or electrically pumping the gain medium using a flash lamp, an arc lamp, a laser, an electric glow discharge, or an electric current to generate an amplified seed laser electromagnetic radiation; and coupling out the amplified seed laser electromagnetic radiation from the etalon.

In another respect, disclosed is an apparatus for resonant optical amplification, the apparatus comprising a seed laser; an etalon comprising a first reflective surface, a gain medium, and a second reflective surface, wherein the gain medium comprises a gain, a length, and a roundtrip gain, wherein the gain medium is positioned between the first reflective surface comprising a first power reflectivity and the second reflective surface comprising a second power reflectivity; the apparatus being configured to: generate electromagnetic radiation from the seed laser; couple the seed laser electromagnetic radiation into the etalon; optically or electrically pump the gain medium using a flash lamp, an arc lamp, a laser, an electric glow discharge, or an electric current to generate an amplified seed laser electromagnetic radiation; and couple out the amplified seed laser electromagnetic radiation from the etalon.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIGS. 1(a), 1(b), and 1(c) are schematic diagrams of Fabry-Pérot interferometers with gain medium with collinear pumping from the incident side, collinear pumping from the transmitted output side, and side pumping, respectively, in accordance with some embodiments.

FIGS. 2(a) and 2(b) are graphs of the transmission and reflection of a Fabry-Pérot interferometer versus wavelength, respectively, with different surface power reflectivities, in accordance with some embodiments.

FIGS. 3(a) and 3(b) are graphs of the forward and backward output of a Fabry-Pérot interferometer versus wavelength, respectively, at different levels of single pass gain, in accordance with some embodiments.

FIGS. 4(a) and 4(b) are schematic diagrams of Fabry-Pérot interferometers with gain medium used as optical amplifiers, in accordance with some embodiments.

FIGS. 5(a) and 5(b) are schematic diagrams of electrical pumping schemes for Fabry-Pérot interferometers with gain medium used as optical amplifiers, in accordance with some embodiments.

FIG. 6 is a schematic diagram of a Fabry-Pérot interferometer with gain medium used as a resonant optical amplifier, in accordance with some embodiments.

FIGS. 7(a) and 7(b) are graphs of the transmitted output gain versus incident power and of the output spectrum from a Fabry-Pérot interferometer optical amplifier with a continuous wave seed input, in accordance with some embodiments.

FIGS. 8(a) and 8(b) are graphs of the pulse train and of the spectrum of the amplified transmitted output from a Fabry-Pérot interferometer optical amplifier with a 10 kHz seed input, in accordance with some embodiments.

FIG. 9 is a block diagram illustrating a method for amplifying an incident signal, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Fabry-Pérot interferometers (also called etalons or Fabry-Pérot etalons) are widely used in lasers, telecommunications, and spectroscopy to control the wavelength of light. Charles H. Townes, Nikolay Basov, Alexander Prokhorov and others first proposed using a Fabry-Pérot interferometer as an open cavity to generate laser emission. In order to generate laser emission using a Fabry-Pérot interferometer, the gain medium is placed between two mirrors. The mirrors are arranged such that light bounces back and forth between the two mirrors, each time passing through the gain medium. Typically, one or both mirrors are partially transparent for a specific wavelength and serve as the output coupler from the cavity. When the gain is greater than the loss for a round trip between the mirrors, a stimulated emission at the specific wavelength is coupled out of the cavity. The simplified lasing condition for a laser may be expressed, assuming steady-state, as shown in equation (1),

R₁R₂e^{g}^{ₒ}^{l}>1 (1)

where R₁ and R₂ are the power reflectivities of the two mirrors and e^{g}^{ₒ}^{l} is the round trip small signal gain. If one or two mirrors are removed from the laser cavity, the gain medium may be used as an optical amplifier. In an optical amplifier, an optical signal from a master oscillator is amplified as the optical signal passes through the gain medium once or multiple times.

In order to obtain higher amplification of the optical signal, the effective length of the gain medium is commonly increased. This can be realized by increasing the gain medium length for a single amplifier, by connecting multiple amplifiers in series, or by doing a multi-pass amplification. However, these methods increase the cost and make the amplifier system much more complicated. Additionally, there may be other difficulties with pumping efficiency and heat dissipation. For an example, for a single pass 2 mm Er-glass gain medium, the gain is about 0.33 dB. Thus, in order to obtain a gain of 10 dB, 30 amplifiers need to be placed in series. To obtain a gain of 20 dB, 60 amplifiers are needed. It is very difficult to align so many amplifiers and in the case of multi-pass amplification, the passes. Another approach for amplification of the optical signal is a regenerative amplifier. However, regenerative amplifiers involve other polarization control components such as waveplates, Pockels cells, and polarizers in the system. These additional components are not only expensive, but also introduce a relatively large optical round trip loss. Therefore, the regenerative amplifier does not work for a gain medium with a small gain.

The embodiment or embodiments described herein may solve these problems as well as others by proposing a new resonant optical amplifier based on a Fabry-Pérot etalon made with a laser gain medium.

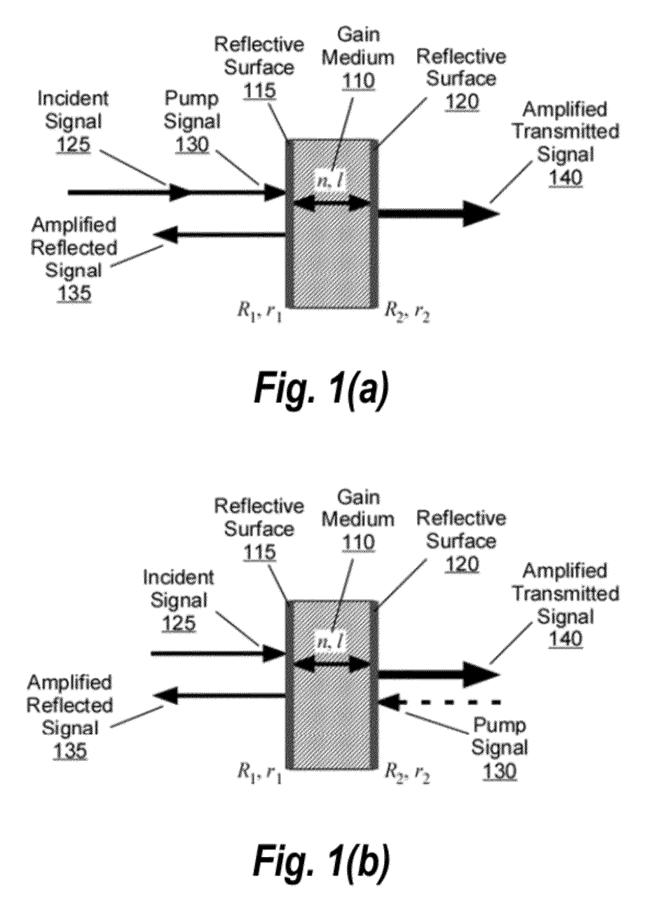

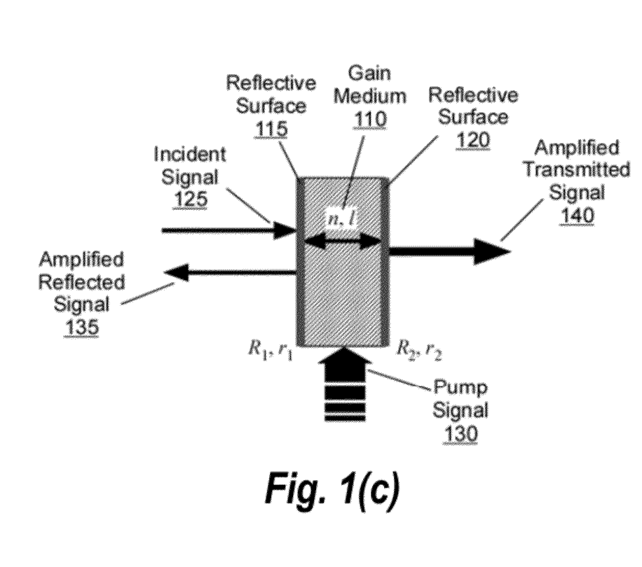

FIGS. 1(a), 1(b), and 1(c) are schematic diagrams of Fabry-Pérot interferometers with gain medium with collinear pumping from the incident side, collinear pumping from the transmitted output side, and side pumping, respectively, in accordance with some embodiments.

In some embodiments, the optical amplifier is based on a Fabry-Pérot interferometer. As shown in FIGS. 1(a), 1(b), and 1(c), the Fabry-Pérot interferometer comprises a laser gain medium 110 in between two parallel flat surfaces 115 and 120. The laser gain medium has a length/and a refractive index of n. The flat surfaces are polished and coated to have power reflectivities of R₁ and R₂, respectively and reflectivities of r₁ and r₂, respectively. In other embodiments, one or both of the surfaces may be curved. The roundtrip gain of the etalon is e^{g}^{ₒ}^{2l}. When the system operates as a resonant optical amplifier, the no-lasing condition is always satisfied as expressed in equation (2),

R₁R₂e^{g}^{ₒ}^{2l}<1 (2)

thus operating in a stable condition. The gain medium 110 may be pumped in multiple different ways. In FIG. 1(a), the incident signal 125 and the collinear pump signal 130 are directed toward the first reflective surface 115. Within the gain medium 110, the incident signal 125 is partially transmitted through the first surface 115 and amplified through the resonant cavity and transmitted through the second surface 120 as an amplified transmitted signal 140. The amplified signal also partially propagates backwards through the first surface 115 as the amplified reflected signal 135. In FIG. 1(b), the collinear pump signal 130 is directed to the second reflective surface 120 from the transmitted output side. In FIG. 1(c), the pump signal 130 is directed toward the gain medium 110 from the side. Optical pump sources may comprise flash lamps, arc lamps, or external lasers.

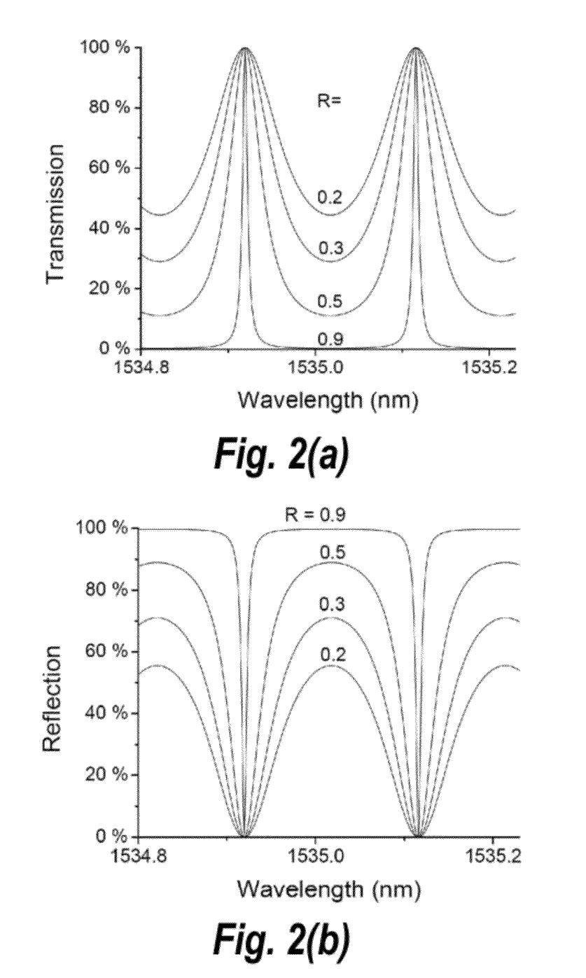

FIGS. 2(a) and 2(b) are graphs of the transmission and reflection of a Fabry-Pérot interferometer versus wavelength, respectively, with different surface power reflectivities, in accordance with some embodiments.

In some embodiments, when a beam is incident into the Fabry-Pérot interferometer, it exhibits resonant effects for both the transmitted and reflected beams. If the etalon material does not have any gain or absorption, the transmission T, and reflection R at wavelength λ may be expressed as in equations (3) and (4), respectively,

$$\begin{matrix}T = \frac{{I}_{trans}}{{I}_{inc}} = {t}^{2} = {\vert \frac{{t}_{1} {t}_{2} {e}^{- i 2 n {k}_{0} l}}{1 - {r}_{1} {r}_{2} {e}^{- i 2 n {k}_{0} l}} \vert}^{2} & ( 3 ) \\ R = \frac{{I}_{ref}}{{I}_{inc}} = {r}^{2} = {\vert {r}_{1} - \frac{{t}_{1}^{2} {r}_{2} {e}^{- i 2 n {k}_{0} l}}{1 - {r}_{1} {r}_{2} {e}^{- i 2 n {k}_{0} l}} \vert}^{2} & ( 4 )\end{matrix}$$

where

$${k}_{0} = \frac{2 π}{λ} ,$$

R₁ and R₂ are the power reflectivities for the two surfaces, r₁=\sqrt{R₁} and r₂=\sqrt{R₂} are the reflectivities, and t₁=\sqrt{1−R₁} and t₂=\sqrt{1−R₂} are the transmittances. Typical transmission and reflection spectrums from a free space Fabry-Pérot etalon with no gain are shown in FIGS. 2(a) and 2(b), respectively. The transmission spectrum exhibits peaks of large transmission at the resonance wavelengths, and thus the reflection reaches its minimum at the resonance wavelengths. In the graphs of FIGS. 2(a) and 2(b), the power reflectivities from two surfaces are equal to each other, and vary from 0.2 to 0.9.

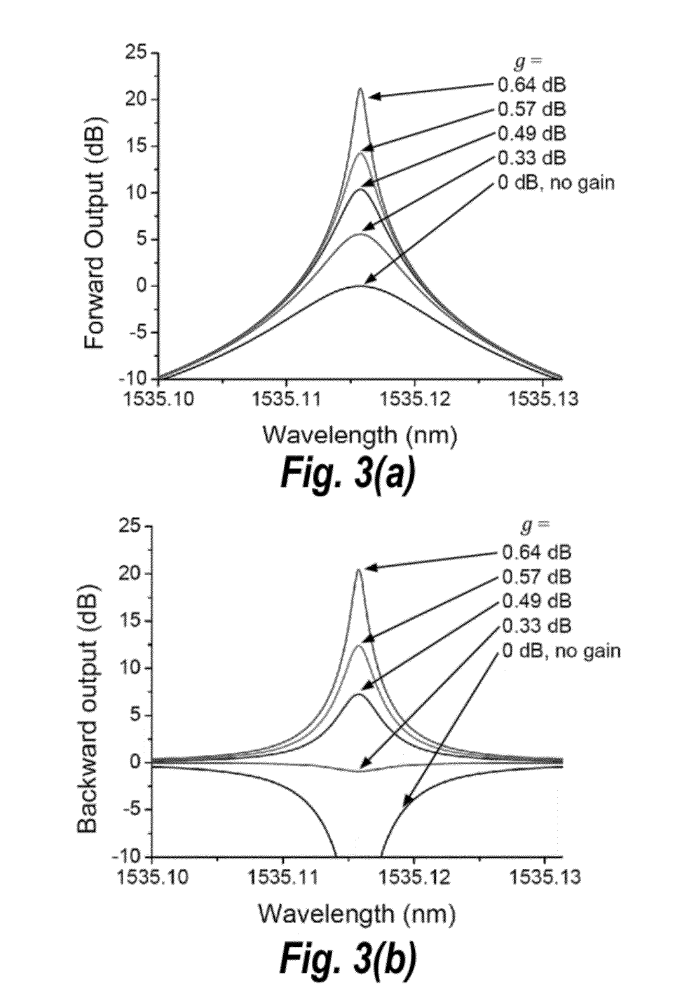

FIGS. 3(a) and 3(b) are graphs of the forward and backward output of a Fabry-Pérot interferometer versus wavelength, respectively, at different levels of single pass gain, in accordance with some embodiments.

In some embodiments, when there is a gain material inside the Fabry-Pérot etalon, its transmission and reflection at wavelength λ may be expressed as in equations (5) and (6), respectively,

$$\begin{matrix}T = \frac{{I}_{trans}}{{I}_{inc}} = {t}^{2} = {\vert \frac{{t}_{1} {t}_{2} \sqrt{g} {e}^{- i 2 n {k}_{0} t}}{1 - {r}_{1} {r}_{2} g {e}^{- i 2 n {k}_{0} t}} \vert}^{2} & ( 5 ) \\ R = \frac{{I}_{ref}}{{I}_{inc}} = {r}^{2} = {\vert {r}_{1} - \frac{{t}_{1}^{2} {r}_{2} g {e}^{- i 2 n {k}_{0} t}}{1 - {r}_{1} {r}_{2} g {e}^{- i 2 n {k}_{0} t}} \vert}^{2} & ( 6 )\end{matrix}$$

where g is the single pass power gain,

$${k}_{0} = \frac{2 π}{λ} ,$$

R₁ and R₂ are the power reflectivities for the two surfaces, r₁=\sqrt{R₁} and r₂=\sqrt{R₂} are the reflectivities, and t₁=\sqrt{1−R₁} and t₂=\sqrt{1−R₂} are the transmittances. In the transmission and reflection graphs of FIGS. 3(a) and 3(b), respectively, R₁ and R₂ are 85%, the refractive index is 1.532, and the gain medium thickness is 4 mm. The single pass power gain g varies from 0 dB (no gain) to 0.64 dB, which always satisfies the no-lasing condition of equation (2). FIG. 3(a) shows that at the resonance wavelength, a gain as high as 21.2 dB is obtained in the forward (transmission) direction. FIG. 3(b) shows that there is also a gain of 20.4 dB in the backward (reflection) direction, where the single pass gain is only 0.64 dB. The results from FIGS. 3(a) and 3(b) show that the Fabry-Pérot etalon with gain medium may be used as a resonant optical amplifier. In the forward direction, the maximum gain of the amplified transmitted signal 140 of FIGS. 1(a), 1(b), and 1(c) is obtained at the etalon's resonance wavelength. Under certain conditions, a positive gain may also be obtained in the backward direction from the reflected signal 135 of FIGS. 1(a), 1(b), and 1(c), with a maximum value at the resonance wavelength. The resonance wavelength depends on the structure and the gain material of the etalon. Therefore, to maximize the gain, the wavelength of the master oscillator may be tuned to the resonance wavelength of the etalon or the resonance wavelength of the etalon may be designed to match the master oscillator's wavelength.

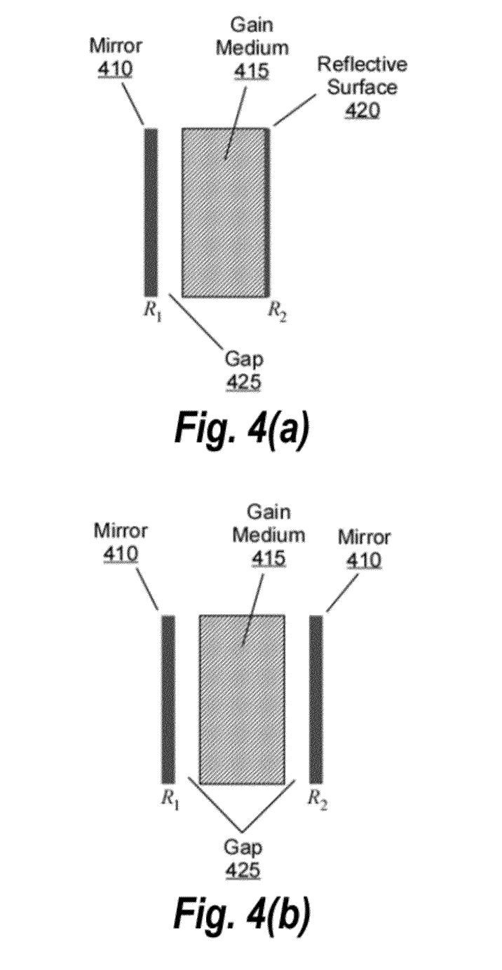

FIGS. 4(a) and 4(b) are schematic diagrams of Fabry-Pérot interferometers with gain medium used as optical amplifiers, in accordance with some embodiments.

In some embodiments, unlike the Fabry-Pérot interferometers of FIGS. 1(a), 1(b), and 1(c) where the reflective coatings are directly on the gain medium, the Fabry-Pérot interferometer optical amplifier may comprise one or two separated mirrors 410 on each side of the gain medium 415 as shown in FIGS. 4(a) and 4(b), respectively. The mirrors 410 and the reflective surface 420 of the gain medium 415 may be either flat or curved. The reflectivity coatings may be coated on the inside surfaces, the outside surfaces, or a combination of both surfaces. The gap or gaps 425 between the mirror 410 and the gain medium 415 may be fixed, tunable, or filled with gas or liquid, or in the configurations in FIGS. 1(a), 1(b), and 1(c), nonexistent. Additionally, the thickness or length/of the gain medium 415 may be fixed or tunable. The gain medium 415 may comprise a solid, a liquid such as a laser dye solution, a gas, or a semiconductor material. Solids, such as crystals, ceramics, or glasses doped with rare-earth ions (e.g. neodymium, ytterbium, or erbium) or transition metal ions (titanium or chromium), yttrium aluminum garnet (YAG), yttrium orthovanadate (YVO₄), sapphire and others may be used as the gain medium. Gases, such as mixtures of helium and neon (HeNe), nitrogen, argon, carbon monoxide (CO), carbon dioxide (CO₂), metal vapors and others may be used as the gain medium. Semiconductors, such as gallium arsenide (GaAs), indium gallium arsenide (InGaAs), gallium nitride (GaN) and others may be used as the gain medium.

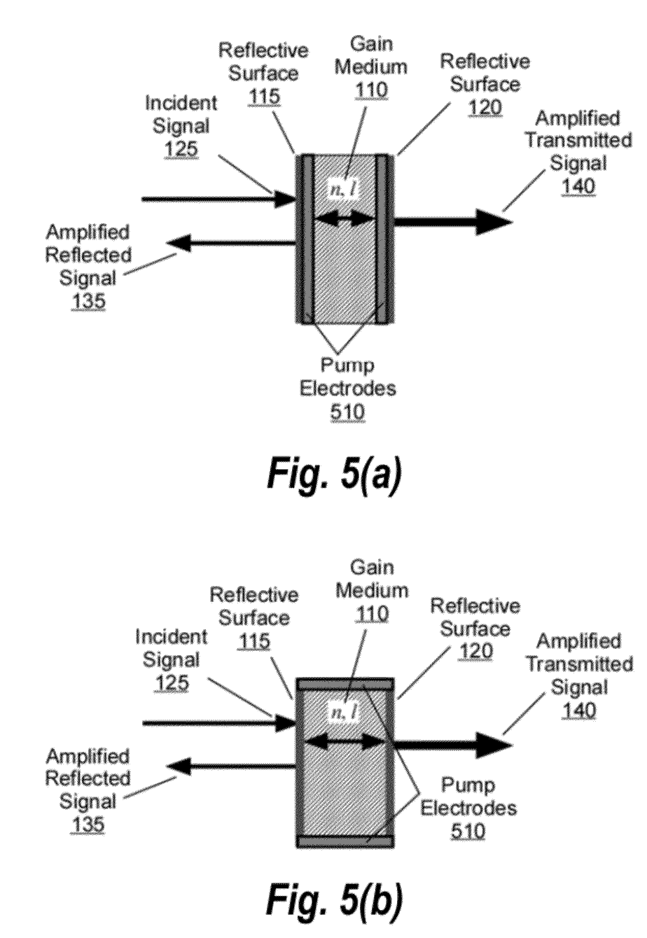

FIGS. 5(a) and 5(b) are schematic diagrams of electrical pumping schemes for Fabry-Pérot interferometers with gain medium used as optical amplifiers, in accordance with some embodiments.

In some embodiments, the gain medium of the Fabry-Pérot interferometer may be electrically pumped. Electrical pumping may include an electric glow discharge to pump a gas gain medium or an electric current to pump a semiconductor gain medium. The electrodes 510 may be applied parallel or perpendicular to the etalon surfaces as shown in FIGS. 5(a) and 5(b), respectively.

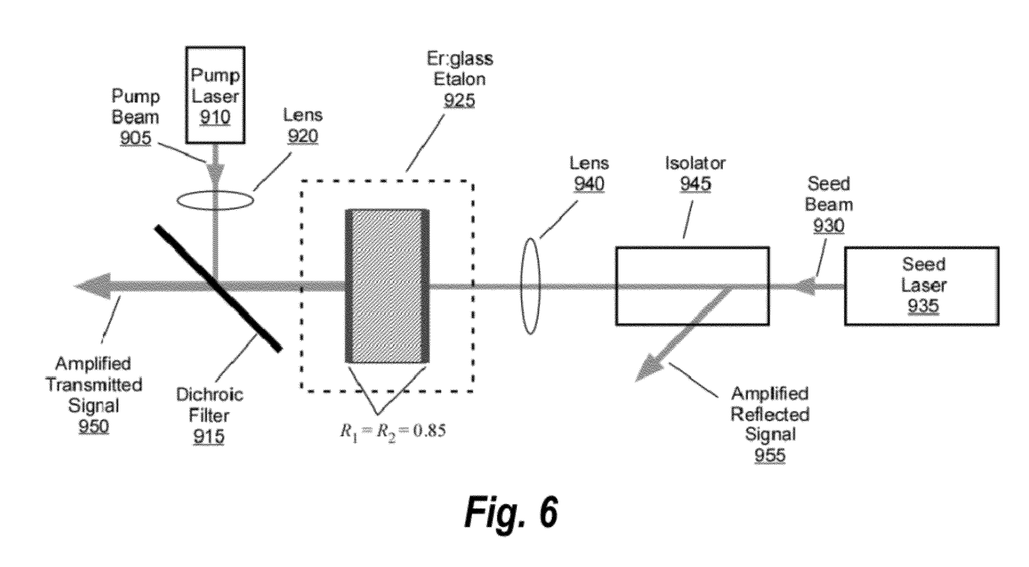

FIG. 6 is a schematic diagram of a Fabry-Pérot interferometer with gain medium used as a resonant optical amplifier, in accordance with some embodiments.

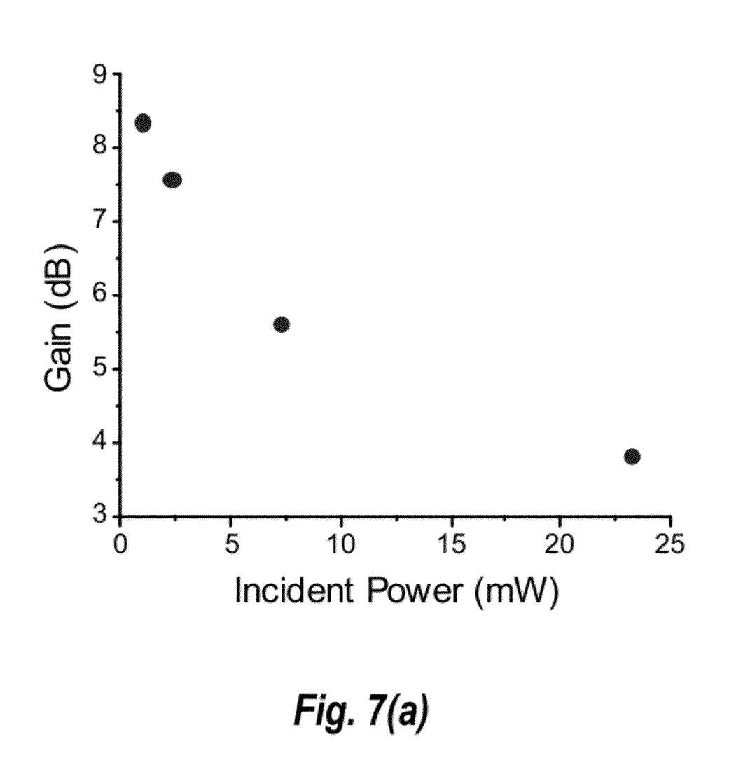

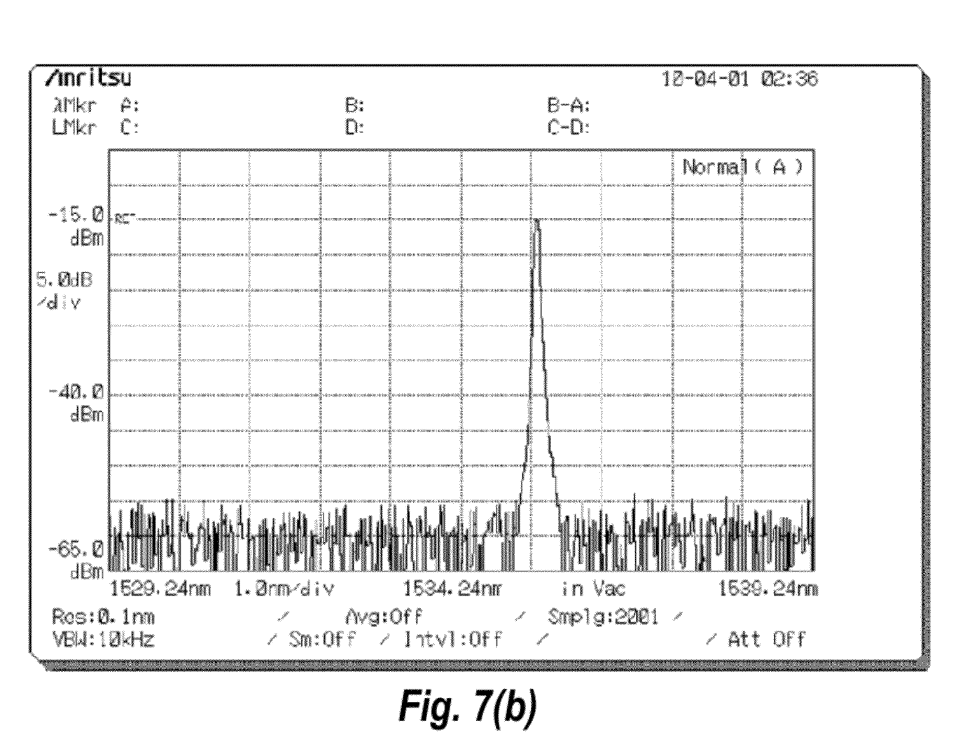

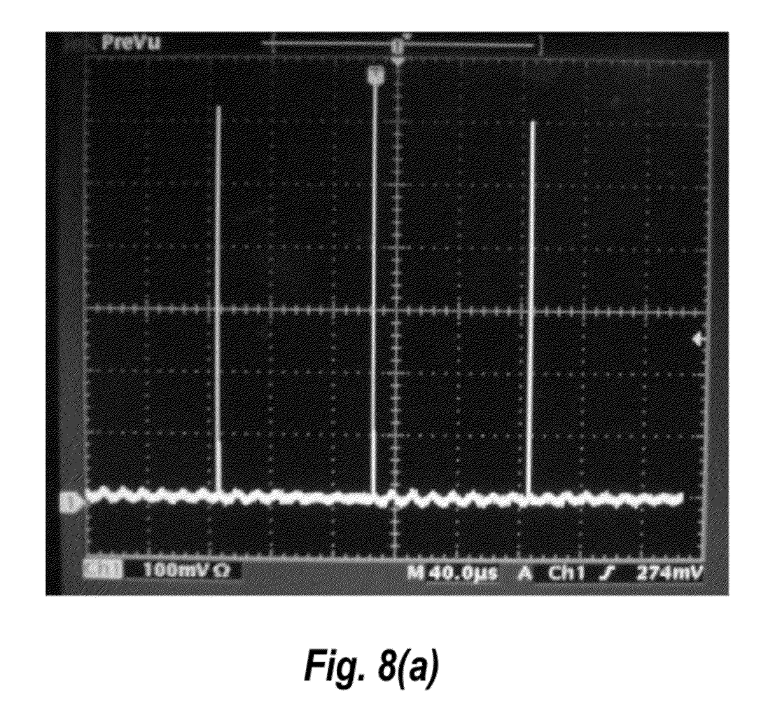

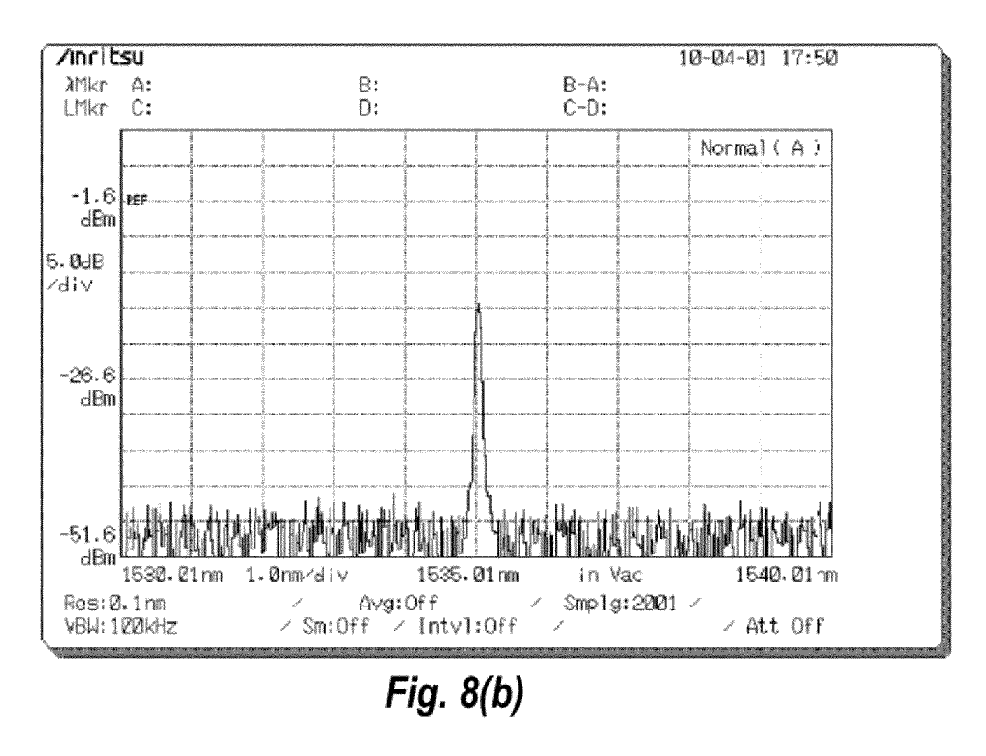

In some embodiments, a 976 nm pump beam 905 from a pump laser 910 is reflected by a dichroic filter 915 and focused with a 10 cm focal length lens 920 into a 4 mm thick Er:glass etalon 925. A 1535 nm seed beam 930 from a seed laser 935 is incident and focused with a 15 cm focal length lens 940 on the Er:glass etalon 925 from the side opposite the pump beam 905. The wavelength of the seed beam 930 is tuned to the resonance wavelength of the Er:glass etalon 925. The two surfaces of the Er:glass etalon are coated to 85% reflectivity. The seed beam 930 is amplified in the Er:glass etalon 925 and output in both the transmission (forward) and reflection (backward) directions. The amplified reflected output may be separated by an isolator 945 with exit windows which may comprise a combination of a Faraday rotator and polarizers. The isolator 945 may be positioned anywhere between the Er:glass etalon 925 and the seed laser 935. The amplified transmission beam 950 and the amplified reflected beam 955 may be combined after being coupled out of the Fabry-Pérot interferometer. The apparatus in FIG. 6 may be used to amplify both continuous wave (CW) and pulsed optical signals. The pulse signals include, but are not limited to, single shot pulses, pulses with repetition rates varying from 0 Hz to 1000 Ghz, and pulses with duration time varying from a few femtoseconds to CW. With the apparatus in FIG. 6 and a CW seed input, the gain in the transmitted output measured up to 8.4 dB. The transmitted output gain versus incident power and the output spectrum are plotted in FIGS. 7(a) and 7(b), respectively. With the apparatus in FIG. 6 and a 200 ns pulsed seed input, a gain of above 20 dB is obtained at a repetition rate from a few Hz to 10 kHz. The output pulse train and the output spectrum of the amplified transmitted output with a 10 kHz seed input are shown in FIGS. 8(a) and 8(b), respectively. In contrast, in a different experimental setup for only a single pass through the 4 mm thick Er:glass, a gain only up to 0.64 dB is obtained under similar pump conditions.

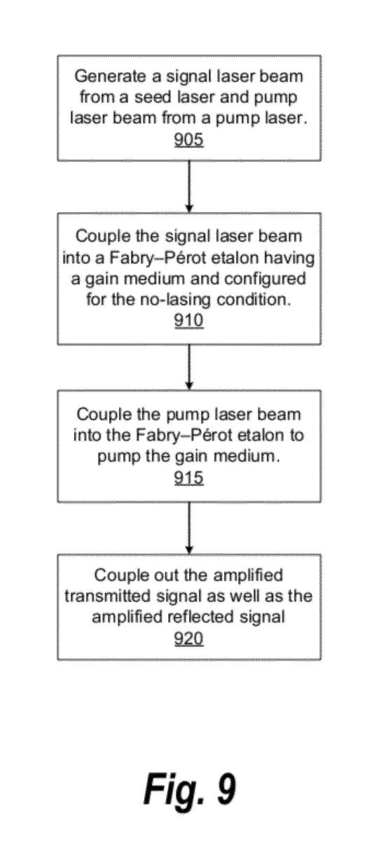

FIG. 9 is a block diagram illustrating a method for amplifying an incident signal, in accordance with some embodiments.

In some embodiments, a seed laser is used to generate a signal laser beam and a pump laser is used to generate a pump laser beam 905. The signal laser beam is coupled into a Fabry-Pérot etalon having a gain medium 910. The pump laser beam is coupled into a Fabry-Pérot to pump the gain medium of the Fabry-Pérot etalon 915. The pump laser beam may be coupled to the etalon with a dichroic filter from either side of the etalon or pumped directly to the side of the gain material of the etalon. The signal laser beam wavelength is at the resonance of the Fabry-Pérot etalon. An amplified transmitted signal as well as an amplified reflected signal are generated and coupled out from the Fabry-Pérot etalon 920. The amplified reflected signal may be separated out using an isolator.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for resonant optical amplification, the method comprising:
generating electromagnetic radiation from a seed laser;
generating electromagnetic radiation from an optical pump source;
coupling the seed laser electromagnetic radiation and the optical pump source electromagnetic radiation into an etalon to generate an amplified seed laser electromagnetic radiation, wherein the etalon comprises a gain medium between a first reflective surface and a second reflective surface; and
coupling out the amplified seed laser electromagnetic radiation from the etalon.

2. The method of claim 1, wherein the etalon further comprises the gain medium comprising a gain gₒ, a length l, and a roundtrip gain e^{g}^{ₒ}^{2l}, wherein the gain medium is positioned between the first reflective surface comprising a first power reflectivity R₁ and the second reflective surface comprising a second power reflectivity R₂, wherein the product of the first power reflectivity, the second power reflectivity, and the roundtrip gain is less than one.

3. The method of claim 1, wherein the seed laser electromagnetic radiation and the optical pump source electromagnetic radiation are coupled into the gain medium through the first reflective surface.

4. The method of claim 1, wherein the seed laser electromagnetic radiation is coupled into the gain medium through the first reflective surface and the optical pump source electromagnetic radiation is coupled into the gain medium through the second reflective surface.

5. The method of claim 1, wherein the optical pump source electromagnetic radiation is coupled into the gain medium through the side of the gain medium.

6. The method of claim 1, wherein the optical pump source comprises at least one of: a flash lamp, an arc lamp, and a laser.

7. The method of claim 1, wherein the wavelength of the seed laser electromagnetic radiation matches the resonance wavelength of the etalon.

8. The method of claim 7, wherein matching the wavelength of the seed laser electromagnetic radiation to the resonance wavelength of the etalon comprises at least one of: an optical means, a mechanical means, a thermal means, and an electrical (electronic) means.

9. The method of claim 1, wherein the first reflective surface comprises a mirror or the polished and coated surface of the gain medium.

10. The method of claim 1, wherein the first and second reflective surfaces are flat or curved.

11. The method of claim 1, wherein the second reflective surface comprises a mirror or the polished and coated surface of the gain medium.

12. The method of claim 1, wherein the gain medium comprises at least one of: a crystal, a ceramic, a glass, neodymium, ytterbium, erbium, titanium, chromium, yttrium aluminum garnet, yttrium orthovanadate, sapphire, a laser dye solution, helium, neon, nitrogen, argon, carbon monoxide, carbon dioxide, metal vapors, gallium arsenide, indium gallium arsenide, and gallium nitride.

13. The method of claim 1, wherein the first and second reflective surfaces are separated from the gain medium by fixed or tunable distances.

14. The method of claim 13, wherein the separations between the first and second reflective surfaces and the gain medium are filled with gas or liquid.

15. The method of claim 1, wherein the length of the gain medium is fixed or tunable.

16. The method of claim 1, wherein the seed laser electromagnetic radiation is generated continuous wave or pulsed.

17. The method of claim 16, wherein the pulsed seed laser electromagnetic radiation comprises at least one of: a single shot pulse, pulses comprising pulse repetition rates ranging from 0 Hz to 1000 GHz, and pulses comprising pulse duration times ranging from a few femtoseconds to continuous wave.

18. A method for resonant optical amplification, the method comprising:
generating electromagnetic radiation from a seed laser;
coupling the seed laser electromagnetic radiation into an etalon, wherein the etalon comprises a gain medium between a first reflective surface and a second reflective surface;
electrically pumping the gain medium using an electric glow discharge or an electric current to generate an amplified seed laser electromagnetic radiation; and
coupling out the amplified seed laser electromagnetic radiation from the etalon.

19. The method of claim 18, wherein the etalon further comprises the gain medium comprising a gain gₒ, a length l, and a roundtrip gain e^{g}^{ₒ}^{2l}, wherein the gain medium is positioned between the first reflective surface comprising a first power reflectivity R₁ and the second reflective surface comprising a second power reflectivity R₂, wherein the product of the first power reflectivity, the second power reflectivity, and the roundtrip gain is less than one.

20. The method of claim 18, wherein the electrical pump comprises electrodes parallel or perpendicular to the surface of the etalon.

21. The method of claim 18, wherein the wavelength of the seed laser electromagnetic radiation matches the resonance wavelength of the etalon.

22. The method of claim 21, wherein matching the wavelength of the seed laser electromagnetic radiation to the resonance wavelength of the etalon comprises at least one of: an optical means, a mechanical means, a thermal means, and an electrical (electronic) means.

23. The method of claim 18, wherein the first reflective surface comprises a mirror or the polished and coated surface of the gain medium.

24. The method of claim 18, wherein the first and second reflective surfaces are flat or curved.

25. The method of claim 18, wherein the second reflective surface comprises a mirror or the polished and coated surface of the gain medium.

26. The method of claim 18, wherein the gain medium comprises at least one of: a crystal, a ceramic, a glass, neodymium, ytterbium, erbium, titanium, chromium, yttrium aluminum garnet, yttrium orthovanadate, sapphire, a laser dye solution, helium, neon, nitrogen, argon, carbon monoxide, carbon dioxide, metal vapors, gallium arsenide, indium gallium arsenide, and gallium nitride.

27. The method of claim 18, wherein the first and second reflective surfaces are separated from the gain medium by fixed or tunable distances.

28. The method of claim 27, wherein the separations between the first and second reflective surfaces and the gain medium are filled with gas or liquid.

29. The method of claim 18, wherein the length of the gain medium is fixed or tunable.

30. The method of claim 18, wherein the seed laser electromagnetic radiation is generated continuous wave or pulsed.

31. The method of claim 30, wherein the pulsed seed laser electromagnetic radiation comprises at least one of: a single shot pulse, pulses comprising pulse repetition rates ranging from 0 Hz to 1000 GHz, and pulses comprising pulse duration times ranging from a few femtoseconds to continuous wave.

32. An apparatus for resonant optical amplification, the apparatus comprising:
a seed laser;
an etalon comprising a first reflective surface, a gain medium, and a second reflective surface; and
an optical pump source;
the apparatus being configured to:
generate electromagnetic radiation from the seed laser;
generate electromagnetic radiation from the optical pump source;
couple the seed laser electromagnetic radiation and the optical pump source electromagnetic radiation into the etalon to generate an amplified seed laser electromagnetic radiation; and
couple out the amplified seed laser electromagnetic radiation from the etalon.

33. The apparatus of claim 32, wherein the etalon further comprises the gain medium comprising a gain gₒ, a length l, and a roundtrip gain e^{g}^{ₒ}^{2l}, wherein the gain medium is positioned between the first reflective surface comprising a first power reflectivity R₁ and the second reflective surface comprising a second power reflectivity R₂, wherein the product of the first power reflectivity, the second power reflectivity, and the roundtrip gain is less than one.

34. The apparatus of claim 32, wherein the seed laser electromagnetic radiation and the optical pump source electromagnetic radiation are coupled into the gain medium through the first reflective surface.

35. The apparatus of claim 32, wherein the seed laser electromagnetic radiation is coupled into the gain medium through the first reflective surface and the optical pump source electromagnetic radiation is coupled into the gain medium through the second reflective surface.

36. The apparatus of claim 32, wherein the optical pump source electromagnetic radiation is coupled into the gain medium through the side of the gain medium.

37. The apparatus of claim 32, wherein the optical pump source comprises at least one of: a flash lamp, an arc lamp, and a laser.

38. The apparatus of claim 32, wherein the wavelength of the seed laser electromagnetic radiation matches the resonance wavelength of the etalon.

39. The apparatus of claim 38, wherein matching the wavelength of the seed laser electromagnetic radiation to the resonance wavelength of the etalon comprises at least one of: an optical means, a mechanical means, a thermal means, and an electrical (electronic) means.

40. The apparatus of claim 32, wherein the first reflective surface comprises a mirror or the polished and coated surface of the gain medium.

41. The apparatus of claim 32, wherein the first and second reflective surfaces are flat or curved.

42. The apparatus of claim 32, wherein the second reflective surface comprises a mirror or the polished and coated surface of the gain medium.

43. The apparatus of claim 32, wherein the gain medium comprises at least one of: a crystal, a ceramic, a glass, neodymium, ytterbium, erbium, titanium, chromium, yttrium aluminum garnet, yttrium orthovanadate, sapphire, a laser dye solution, helium, neon, nitrogen, argon, carbon monoxide, carbon dioxide, metal vapors, gallium arsenide, indium gallium arsenide, and gallium nitride.

44. The apparatus of claim 32, wherein the first and second reflective surfaces are separated from the gain medium by fixed or tunable distances.

45. The apparatus of claim 44, wherein the separations between the first and second reflective surfaces and the gain medium are filled with gas or liquid.

46. The apparatus of claim 32, wherein the length of the gain medium is fixed or tunable.

47. The apparatus of claim 32, wherein the seed laser electromagnetic radiation is generated continuous wave or pulsed.

48. The apparatus of claim 47, wherein the pulsed seed laser electromagnetic radiation comprises at least one of: a single shot pulse, pulses comprising pulse repetition rates ranging from 0 Hz to 1000 GHz, and pulses comprising pulse duration times ranging from a few femtoseconds to continuous wave.

49. An apparatus for resonant optical amplification, the apparatus comprising:
a seed laser;
an etalon comprising a first reflective surface, a gain medium, and a second reflective surface; and
an electrical pump source;
the apparatus being configured to:
generate electromagnetic radiation from the seed laser;
couple the seed laser electromagnetic radiation into the etalon;
electrically pump the gain medium using an electric glow discharge or an electric current to generate an amplified seed laser electromagnetic radiation; and
couple out the amplified seed laser electromagnetic radiation from the etalon.

50. The apparatus of claim 49, wherein the etalon further comprises the gain medium comprising a gain gₒ, a length l, and a roundtrip gain e^{g}^{ₒ}^{2l}, wherein the gain medium is positioned between the first reflective surface comprising a first power reflectivity R₁ and the second reflective surface comprising a second power reflectivity R₂, wherein the product of the first power reflectivity, the second power reflectivity, and the roundtrip gain is less than one.

51. The apparatus of claim 49, wherein the electrical pump source comprises electrodes parallel or perpendicular to the surface of the etalon.

52. The apparatus of claim 49, wherein the wavelength of the seed laser electromagnetic radiation matches the resonance wavelength of the etalon.

53. The apparatus of claim 52, wherein matching the wavelength of the seed laser electromagnetic radiation to the resonance wavelength of the etalon comprises at least one of: an optical means, a mechanical means, a thermal means, and an electrical (electronic) means.

54. The apparatus of claim 49, wherein the first reflective surface comprises a mirror or the polished and coated surface of the gain medium.

55. The apparatus of claim 49, wherein the first and second reflective surfaces are flat or curved.

56. The apparatus of claim 49, wherein the second reflective surface comprises a mirror or the polished and coated surface of the gain medium.

57. The apparatus of claim 49, wherein the gain medium comprises at least one of: a crystal, a ceramic, a glass, neodymium, ytterbium, erbium, titanium, chromium, yttrium aluminum garnet, yttrium orthovanadate, sapphire, a laser dye solution, helium, neon, nitrogen, argon, carbon monoxide, carbon dioxide, metal vapors, gallium arsenide, indium gallium arsenide, and gallium nitride.

58. The apparatus of claim 49, wherein the first and second reflective surfaces are separated from the gain medium by fixed or tunable distances.

59. The apparatus of claim 58, wherein the separations between the first and second reflective surfaces and the gain medium are filled with gas or liquid.

60. The apparatus of claim 49, wherein the length of the gain medium is fixed or tunable.

61. The apparatus of claim 49, wherein the seed laser electromagnetic radiation is generated continuous wave or pulsed.

62. The apparatus of claim 61, wherein the pulsed seed laser electromagnetic radiation comprises at least one of: a single shot pulse, pulses comprising pulse repetition rates ranging from 0 Hz to 1000 GHz, and pulses comprising pulse duration times ranging from a few femtoseconds to continuous wave.
